(19) United States
(12) Patent Application Publication
(10) Pub. No.: US 2007/0108297 A1
(43) Pub. Date: May 17, 2007

(54) Adaptation of transponder card performance to available power

(76) Inventor: Colin D. Bates, Lesmahagow (GB)

Correspondence Address: SCHNECK & SCHNECK, P.O. BOX 2-E, SAN JOSE, CA, 95109-0005, US

(21) Appl. No.: 11/273,649

(22) Filed: Nov. 14, 2005

(51) Int. Cl. G06K 19/06; G06K 7/08

(52) U.S. Cl. 235/492; 235/451

(57) ABSTRACT

A smart card operates within an electromagnetic field produced at radio or microwave frequencies and rectifies the received field to provide power for operation of a load device. The field strength received by the smart card varies due to differing strengths of generation sources, proximity of the card to a source, and a presence of other active cards in the field. The amount of transmitted power available to supply an operation of the smart card varies in proportion to the strength of the field received by the card. The smart card detects the amount of power available and adjusts a performance point of the smart card load so that an amount of power consumed is appropriate to the amount of power received. In the event that the amount of power received exceeds an amount of power required, a shunting device is employed to regulate power to the smart card load.

### TECHNICAL FIELD

The present invention relates to high frequency electromagnetic transponders. More particularly, the invention relates to a device and method for detecting an amount of power transmitted and adjusting a performance level of a load device to correspond to a magnitude of available power received.

### BACKGROUND ART

Smart card technology is a means of communication, detection, and power transmission between a sending unit and a receiving unit. Smart cards are generally considered as part of radio frequency identification (RFID) or electronic article surveillance (EAS) technologies. Radio frequency or microwave electromagnetic fields are generated by a reader (detector) and received by a transponder (i.e., a smart card). The combination of the reader and transponder may be used for identification tags, anti-theft devices, article surveillance, and security cards. Generally, smart card technology allows for the reader to monitor the transponder through electromagnetic coupling.

A coil and capacitor form a receiver section of the smart card. A coil and capacitor connected in parallel is commonly known as a “tank circuit.” When the tank circuit is energized, subsequent oscillations of current and electromagnetic fields result in an energy exchange back and forth between inductor and capacitor. Energizing may occur by exposing the tank circuit to an electromagnetic field at either radio or microwave frequencies. A particular value of inductance and capacitance allows the exchange of energy at a single frequency known as the resonant frequency. The resonant frequency of oscillation is given by the equation

$${f}_{Resonant} = \frac{1}{2 π \sqrt{LC}} ,$$

where L is a value of inductance of the coil and C is an amount of capacitance of the capacitor.

The reader generates an electromagnetic field with a generator frequency, f_{G}. When the generator frequency, f_{G} equals the resonant frequency, f_{Resonant}, of the transponder, the energy within the generated field is coupled to the transponder. The tank circuit of the transponder will develop a “sympathetic oscillation” at the generator frequency, f_{G}.

With reference to FIG. 1, a coupling coil 112 and a tuning capacitor 114 are connected in parallel to form a receiver section 110 in a prior art circuit diagram 100. An input of a rectifying section 120 is connected to the receiver section 110. The rectifying section 120 is made from a full-wave rectifier bridge 125. A regulating section 130 connects to an output of the rectifying section 120 and contains a shunt regulator 135 connected across the inputs to the regulating section 130. A load section 140 connects to an output of the regulating section 130 and contains a smart card load 145 across the inputs of the load section 140.

Values of inductance and capacitance for the coupling coil 112 and the tuning capacitor 114 respectively, are selected for an appropriate resonant frequency of operation. For optimal coupling of energy, the resonant frequency of the smart card corresponds to the generated frequency, f_{G}, of a reader (detector). When the smart card is exposed to a generated field with a generator frequency, f_{G}, that equals the resonant frequency, f_{Resonance}, energy from the generated field is coupled to the receiver section 110.

On each oscillation of the receiver section 110, energy is supplied to the rectifying section 120. A positive phase of oscillation produces a conduction path from a first terminal 116 of the receiver section 110 and continues on through a first branch 122 of the rectifier bridge 125, the regulating section 130, the load section 140, a first return path branch 124 of the rectifier bridge 125, and back to a second (complementary) terminal 118 of the receiver section 110. A negative phase of oscillation produces a conduction path from the second terminal 118 of the receiver section 110 and continues on through a second branch 126 of the rectifier bridge 125, the regulating section 130, the load section 140, of a second return path branch 128 of the rectifier bridge 125, and back to the first terminal 116 of the receiver section 110.

An amount of power available to supply a transponder load device varies proportionately with the strength of the electromagnetic field received. Where the power for a transponder load depends on the amount of power received from an electromagnetic field, coordinating available power and the performance of the load is highly desirable. Optimally, there would be a way for the transponder to detect the amount of power available from the generated field and adjust the performance of the load device to consume an amount of energy appropriate to the level of power received from the generated field. Additionally, the same power detection mechanism could be available to regulate the power supplied to the load to prevent saturation of the load device when ample available power exists.

### SUMMARY

A smart card operates within an electromagnetic field produced at radio or microwave frequencies and rectifies the received field to provide power for operation of a load device. The field strength received by the smart card varies due to differing strengths of generation sources, proximity of the card to a source, and a presence of other cards in the field. The amount of transmitted power available to supply an operation of the smart card varies in proportion to the strength of the field received by the card. The smart card detects the amount of power available and adjusts a performance point of the smart card load so that an amount of power consumed is appropriate to the amount of power received. In the event that more than adequate power is available from the generated field, a shunting device is employed to regulate voltage supplied to the smart card load.

### BRIEF DESCRIPTION OF DRAWINGS

FIG. 1 is a prior art circuit diagram of a contactless smart card.

FIG. 2 is an exemplary circuit diagram of a contactless smart card with a field strength detector and performance adapting load.

FIG. 3 is an exemplary process flow diagram of a method to adapt transponder performance to available power.

### DETAILED DESCRIPTION

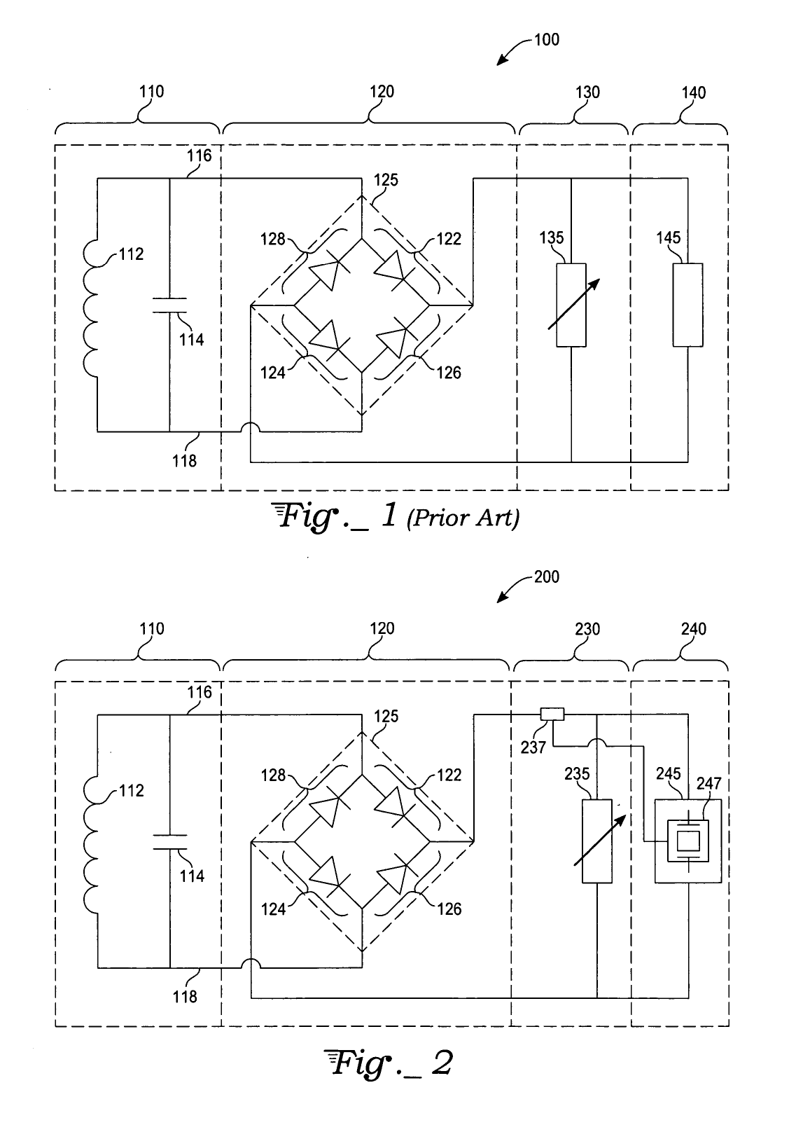

With reference to FIG. 2, a coupling coil 112 and a tuning capacitor 114 are connected in parallel to form a receiver section 110 of an exemplary circuit diagram 200 of a contactless smart card. A rectifying section 120 input is connected to the receiver section 110 and is made from a rectifier bridge 125. A regulating section 230 connects to an output of the rectifying section 120 and contains a detector 237 connected to an input of the regulating section 230. A shunt regulator 235 connects from the output of the regulating section 230 to ground. A load section 240 connects to an output of the regulating section 230 and contains a smart card load 245 across the inputs of the load section 240.

Values of inductance and capacitance for the coupling coil 112 and the tuning capacitor 114 respectively, are selected for an appropriate resonant frequency of operation. For optimal coupling of energy, the resonant frequency of the smart card corresponds to the generated frequency, f_{G}, of a reader (detector). When the smart card is exposed to an electromagnetic field with a generator frequency, f_{G}, that equals the resonant frequency, f_{Resonance}, of the transponder, energy from the generated field is coupled to the receiver section 110.

On each oscillation of the receiver section 110, energy is fed to the rectifying section 120. Continuous exposure to the electromagnetic field replenishes the energy supplied to the rectifying section 120. A positive phase of oscillation produces a conduction path from a first terminal 116 of the receiver section 110, through a first branch 122 of the rectifier bridge 125, through the regulating section 230 and load section 240, through a first return path 124 portion of the rectifier bridge 125, and back to a second, complementary terminal 118 of the receiver section 110. A negative phase of oscillation produces a conduction path through the second terminal 118 of the receiver section 110, through a second branch of the rectifier bridge 125, through the regulating section 230 and load section 240, through a second return path 128 portion of the rectifier bridge 125, and back to the first terminal 116 of the receiver section 110.

The amount of energy available to be supplied to the rectifying section 120 is dependent upon and directly proportional to the strength of the generated field. For instance, in a typical application, an amount of available power from the generated field varies from 4 milliamps (mA) to 80 mA. A stronger generated field produces more energy for the load section 240. The strength of the generated field at the smart card depends on the strength of the field produced, the proximity of the smart card to the generating source, and the presence of other cards in the field. The load section 240 will have varying amounts of energy available for the smart card load 245 depending upon the strength of the field to which the smart card is exposed.

The detector 237 senses the amount of power supplied from the generated field and provided by the rectifier section 120 by monitoring the current coming from the rectifier bridge 125. The monitored current at the output of the detector 237 produces an indicator signal proportional to the amount of power produced by the rectifier section 120. Since the amount of power provided by the rectifier section 120 comes from the electromagnetic field, the indicator is a field strength signal. The indicator signal is supplied to a clock frequency regulator 247 within the smart card load 245. The clock frequency regulator 247 determines the clock frequency provided to a microprocessor (not shown) in the smart card load section 240. The clock frequency regulator 247 may be implemented, for example, by a voltage-controlled oscillator. A relatively higher indicator signal produces a proportionately higher clock frequency output to the microprocessor. An alternative exemplary embodiment of the clock frequency regulator 247 is a digital clock divider controlled by an analog-to-digital converter monitoring the current through the rectifier.

The microprocessor and smart card load 245 will consume power proportionate to the power available from the generated field based on the frequency output by the clock frequency regulator 247. The clock frequency regulator 247, therefore, acts as a performance adapter for matching an operating point of the smart card load 245 to available power from the generated field. The operating point is set by the indicator signal supplied by the detector 237 to the frequency regulator 247. A typical smart card may consume between 2 mA and 20 mA when supplied with a field of sufficient strength to supply a corresponding performance level. The combination of the detector 237, the indicator signal, and the clock frequency regulator 247 produce a performance level in a microprocessor appropriate to the power available in the generated electromagnetic field available to the transponder.

A feedback signal (not shown) is provided to the shunt regulator 235. The feedback signal is produced by devices (not shown) monitoring, for example, a voltage produced by the smart card. The shunt regulator 235 controls the voltage supplied to the load section 240. The greater the magnitude of power provided by the rectifier section 120, the greater the feedback signal and the greater the amount of shunting provided by the shunt regulator 235. For a sufficiently low magnitude of electromagnetic field the shunt regulator 235 receives a low enough feedback signal to decrease the amount of shunting by the shunt regulator 235 to a level of effectively no shunting.

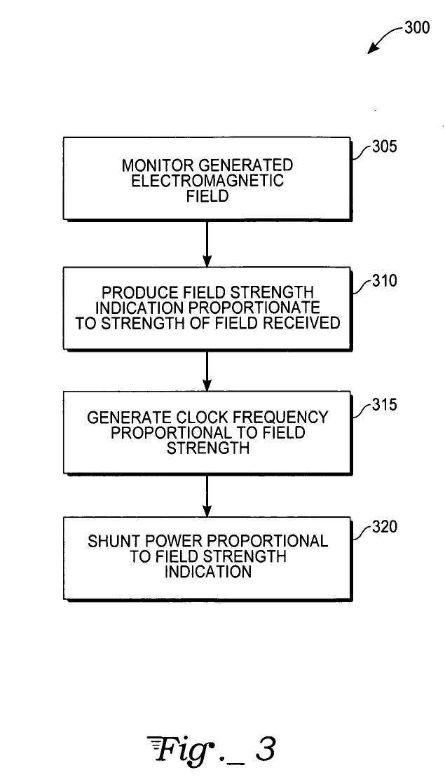

With reference to FIG. 3, an exemplary process flow diagram 300 of a method to adapt transponder performance commences with monitoring 305 the generated electromagnetic field. The method continues with producing 310 a field strength indication proportionate to the strength of the field received and is followed by a step of generating 315 a clock frequency proportional to the field strength. A next step in the process is a shunting 320 of power proportional to the field strength indication.

While various portions of a transponder card have been depicted with exemplary components and configurations, an artisan in the electromagnetic field would readily recognize alternative embodiments for accomplishing a similar result. For instance, a detector has been presented as a single series device with an indicator signal output. An artisan in the field would recognize a possibility for various networks of field effect transistor devices to conduct the current from the rectifier section 120 (FIG. 2) and produce voltage drops across an on-channel resistance of one of the transistor devices proportionate to a rectifier current. Similarly, an artisan familiar with the field would also recognize the capability of an input gate of a field effect transistor to detect a voltage drop across a series resistor to effect the same detection capability.

Additionally, a clock frequency regulator 247 has been represented by a voltage-controlled oscillator. One skilled in the art could readily conceive of a phase-locked-loop frequency synthesizer employing phase detection, clock dividers, and prescalers to provide a frequency to produce an appropriate performance level of a microprocessor. The smart card load 245 has been represented by a microprocessor. An artisan in the field of transponders would conceive of other process specific circuitry to be incorporated into a smart card. For instance, an LED, counter, or signal transmitter could be triggered and powered by the electromagnetic field the transponder is immersed in to provide surveillance, tracking, or inventory capabilities. The specification and drawings are therefore to be regarded in an illustrative rather than a restrictive sense.

What is claimed is:

1. An electromagnetic field receiving device comprising:
a receiver capable of receiving a transmitted electromagnetic field, the receiver being configured to produce an oscillating electrical signal;
a rectifier coupled to the receiver, the rectifier capable of receiving the oscillating electrical signal and configured to produce a level of power proportional to a magnitude of the oscillating electrical signal received;
a detector coupled to the rectifier, the detector capable of receiving the oscillating electrical signal and configured to produce an indicator signal proportional to a magnitude of power received;
a load device coupled to the rectifier, the load device capable of receiving power and performing calculations;
a performance adapter coupled to the detector, the rectifier, and the load device, the performance adapter capable of receiving the indicator signal and configured to adjust a performance level of the load device proportional to the indicator signal; and
a regulator, coupled to the rectifier capable of receiving a feedback signal and configured to select an operating point for the load device proportional to the feedback signal.

2. The electromagnetic field receiving device of claim 1, wherein the receiver is further comprised of an inductor coupled in parallel with a capacitor.

3. The electromagnetic field receiving device of claim 1, wherein the rectifier is comprised of a bridge rectifier circuit.

4. The electromagnetic field receiving device of claim 1, wherein the load device is a microprocessor.

5. The electromagnetic field receiving device of claim 1, wherein the performance adapter is a phase-lock-loop frequency synthesizer with a voltage-controlled oscillator control.

6. An electromagnetic field receiving device comprising:
a receiver means for producing an oscillating electrical signal at a power level proportional to an electromagnetic field received;
a rectifier means for producing a level of power proportional to the level of the oscillating electrical signal received;
a detector means for producing an indicator signal proportional to the level of power received;
a processor means for performing calculations;
a regulator means for providing an adjusted power level for the processor means; and
an adapter means for controlling a performance level of the processor means.

7. The electromagnetic field receiving device of claim 6, wherein the receiving means is an inductor coupled in parallel with a capacitor.

8. The electromagnetic field receiving device of claim 6, wherein the rectifier means is a bridge rectifier.

9. The electromagnetic field receiving device of claim 6, wherein the processor means is a microprocessor.

10. The electromagnetic field receiving device of claim 6, wherein the adapter means is a phase-lock-loop frequency synthesizer with a voltage-controlled oscillator control.

11. A method for adapting transponder performance comprising:
monitoring a generated electromagnetic field;
producing a field strength indication proportional to a magnitude of the generated electromagnetic field received;
generating a clock frequency proportional to a magnitude of the field strength indication; and
shunting an amount of power proportional to a magnitude of the field strength indication.

12. The electromagnetic field receiving device of claim 11, wherein power is shunted when a current produced from the generated electromagnetic field is in excess of 80 mA.
